(19) United States
(12) Patent Application Publication
(10) Pub. No.: US 2003/0096127 A1
(43) Pub. Date: May 22, 2003

(54) Perpendicular magnetic recording medium and magnetic

(76) Inventors: Takashi Hikosaka, Tokyo (JP); Soichi Oikawa, Chiba-shi (JP); Futoshi Nakamura, Ichikawa-shi (JP); Takeshi Iwasaki, Funabashi-shi (JP); Hiroshi Sakai, Ichihara-shi (JP); Akira Sakawaki, Ichihara-shi (JP)

Correspondence Address: PILLSBURY WINTHROP, LLP, P.O. BOX 10500, MCLEAN, VA, 22102, US

(21) Appl. No.: 10/234,719

(22) Filed: Sep. 5, 2002

(30) Foreign Application Priority Data
Nov. 22, 2001 (JP) 2001-358205

(51) Int. Cl. B32B 27/06

(52) U.S. Cl. 428/480; 428/694 MM; 428/693

(57) ABSTRACT

Epitaxial growth of a magnetic grain crystal in a perpendicular magnetic recording layer is interrupted.

### CROSS-REFERENCE TO RELATED APPLICATIONS

This application is based upon and claims the benefit of priority from the prior Japanese Patent Application No. 2001-358205, filed Nov. 22, 2001, the entire contents of which are incorporated herein by reference.

### BACKGROUND OF THE INVENTION

1. Field of the Invention

The present invention relates to a recording medium used in a magnetic disk apparatus and, more particularly, to a perpendicular magnetic recording medium used in a perpendicular magnetic recording system.

2. Description of the Related Art

Conventionally, a magnetic recording apparatus uses a longitudinal magnetic recording system in which the magnetization direction in a magnetic recording layer points in the longitudinal direction. Unfortunately, this longitudinal magnetic recording system has the problem that if, in order to increase the recording density, the size of magnetic grains in the recording layer is decreased to improve the medium Signal to noise ratio, SNR, recorded information disappears owing to thermal decay. To improve the medium SNR and prevent thermal decay, the conventional approach is to raise the magnetic anisotropy of the recording layer. However, the magnetic anisotropy can no longer be raised since the ease with which a recording head records information must be taken into consideration. This makes it difficult to improve the medium SNR by reducing medium noise and to improve the thermal decay resistance at the same time.

In contrast, in a perpendicular magnetic recording system in which the magnetization direction in a magnetic recording layer is perpendicular, magnetic fields which stabilize magnetization interact with each other in a magnetization transition region. This forms a steep transition region and increases the recording density. In addition, a recording layer thickness for obtaining the same recording resolution is larger than in a longitudinal magnetic recording medium. This is also advantageous against thermal decay since the magnetic grain volume in the recording layer can be increased. In case that the recording density of a bit is small, a large demagnetizing field is formed in a recording bit, and this increases thermal decay. However, thermal decay is stable at high density, unlike in a longitudinal magnetic recording medium.

Furthermore, when a perpendicular two-layered film medium having a soft magnetic film below a perpendicular magnetic recording layer is used, the head magnetic field can be increased compared to longitudinal magnetic recording. Hence, a material having large anisotropy can be used as a medium.

For these reasons, the perpendicular magnetic recording system has attracted attention in recent years.

As described above, when compared to longitudinal magnetic recording, the film thickness of the recording layer can be increased in perpendicular magnetic recording. However, if this film thickness is too large, the writing capability of the head is not satisfactory, so high recording density cannot be accomplished. When recording density in the future is taken into consideration, however, the film thickness of the recording layer is preferably at least 50 nm or less, and more preferably, 30 nm or less.

A high SNR of the recording medium can be also an important characteristic as in the longitudinal magnetic recording medium. In the longitudinal magnetic recording medium, it is known as it is effective to decrease the size of magnetic grains forming the recording layer. It is known as the SNR can also be effectively raised by decreasing the crystal grain size in the longitudinal direction and inserting a nonmagnetic layer between recording layers. Even in a perpendicular magnetic recording medium, as described in, e.g., Jpn. Pat. Appln. KOKAI Publication No. 7-176027, a nonmagnetic interlayer is formed between recording layers, and each layer is epitaxially grown. However, when individual magnetic layers are epitaxially grown in a perpendicular magnetic recording medium, noise components are also aligned in these layers, so low noise cannot be achieved. The influence of this alignment of noise components in the upper and lower magnetic layers is particularly significant in a perpendicular two-layered film medium capable of ideal perpendicular magnetic recording. In addition, since the nonmagnetic interlayer is formed between the upper and lower magnetic layers, these magnetic layers are magnetically disconnected. Accordingly, the magnetization reversal unit is small in the film thickness direction, so the medium is vulnerable to thermal decay. Also, as a perpendicular medium having a stacked structure using no interlayer, Jpn. Pat. Appln. KOKOKU Publication No. 03-57535 discloses a Co-Cr perpendicular magnetic recording medium whose signal-to-noise ratio is improved by stacking a plurality of magnetic layers in which the composition distribution of Cr changes in the film thickness direction, and by combining this recording medium with a ring recording head. Unfortunately, the film thickness of this magnetic recording layer is as large as 100 to 1,000 nm. If this magnetic recording layer is thin, e.g., 50 nm thick, the Cr composition distribution does not sufficiently change in the film thickness direction. As a consequence, the SNR cannot be improved.

As described above, in a perpendicular magnetic recording medium it is desirable to achieve both a high thermal decay resistance and a high SNR and to decrease the thickness of a magnetic recording layer.

### BRIEF SUMMARY OF THE INVENTION

The present invention has been made to solve the above problem, and has as its object to realize magnetic recording having a high thermal decay resistance and a high medium SNR.

A perpendicular magnetic recording medium according to the present invention is characterized by comprising a substrate, and a perpendicular magnetic recording layer which is formed on the substrate and in which epitaxial growth is interrupted.

A magnetic recording/reading apparatus according to the present invention is characterized by comprising a perpendicular magnetic recording medium having a substrate, and a perpendicular magnetic recording layer which is formed on the substrate and in which epitaxial growth is interrupted,

driving mechanism for supporting and rotating the magnetic recording medium, and

a single-pole recording head which records information on the magnetic recording medium.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention and, together with the generation description given above and the detailed description of the preferred embodiments given below, serve to explain the principles of the invention.

FIG. 1 is a view showing a model which represents an example of the state of a crystal in a magnetic recording layer used in a magnetic recording medium of the present invention;

FIG. 2 is a view showing a model which represents another example of the state of the crystal in the magnetic recording layer used in the magnetic recording medium of the present invention;

FIG. 3 is a sectional view showing an example of the structure of the magnetic recording medium of the present invention;

FIG. 4 is a sectional view showing another example of the structure of the magnetic recording medium of the present invention;

FIG. 5 is a schematic view showing an example of the arrangement of a magnetic recording/reading apparatus of the present invention;

FIG. 6 is a sectional view showing still another example of the structure of the magnetic recording medium of the present invention;

FIG. 7 is a sectional view showing still another example of the structure of the magnetic recording medium of the present invention; and

FIG. 8 is a sectional view showing still another example of the structure of the magnetic recording medium of the present invention.

### DETAILED DESCRIPTION OF THE INVENTION

A perpendicular magnetic recording medium of the present invention has a substrate and a perpendicular magnetic recording layer formed on the substrate. In this perpendicular magnetic recording layer, epitaxial crystal growth of magnetic grains is interrupted.

In the present invention, the perpendicular magnetic recording layer has in its film thickness direction a portion in which epitaxial crystal growth of magnetic grains is interrupted. This prevents noise generated on one side of the portion of interruption from matching noise generated on the other side, thereby improving the medium SNR. Also, the perpendicular magnetic recording layer used in the present invention is not magnetically disconnected in the film thickness direction, although epitaxial crystal growth is interrupted in that direction. Accordingly, the thickness in the film thickness direction of a magnetization reversal unit becomes sufficient, so a high thermal decay resistance can be obtained.

The perpendicular magnetic recording layer preferably has two or more layers.

The thickness of this perpendicular magnetic recording layer is preferably 5 to 50 nm, and more preferably, 10 to 30 nm. If this thickness is less than 5 nm, the magnetization amount in the recording layer is not sufficient, and this decreases the head output. If an apparatus is assembled using this recording medium, it is often impossible to obtain a high error rate. On the other hand, if the thickness exceeds 50 nm, the writing capability of the head becomes unsatisfactory, and the recording resolution often drops.

An example of the structure in which epitaxial crystal growth is interrupted is a perpendicular magnetic recording layer which has first and second magnetic layers in this order on a substrate, and in which the easy axis of magnetization of the magnetic grains crystal in the first magnetic layer does not match the easy axis of magnetization of the magnetic grain crystal in the second magnetic layer.

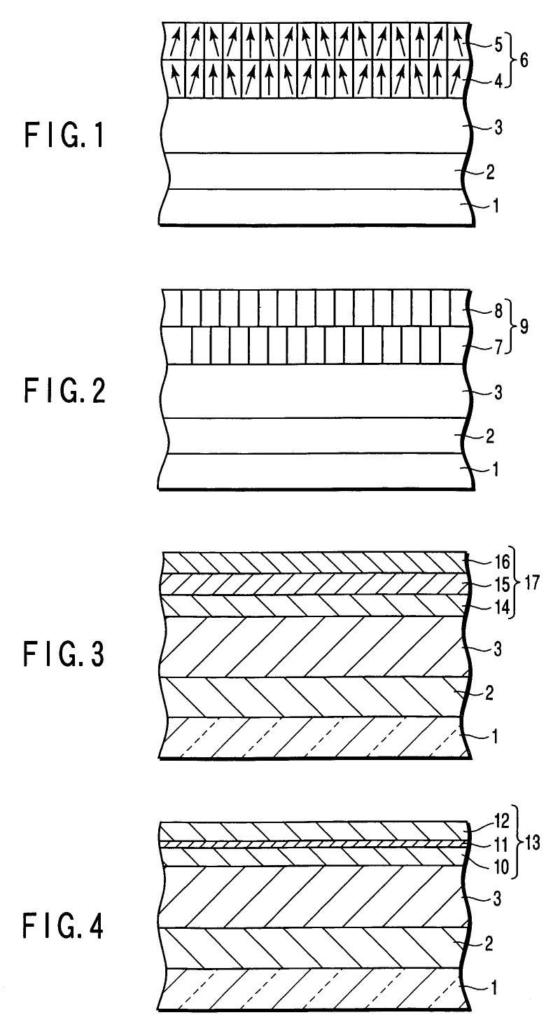

FIG. 1 is a view showing a model which represents a magnetic recording medium having two magnetic layers different in easy axis of magnetization.

As shown in FIG. 1, this magnetic recording medium has a structure in which a bias application layer 2, a soft magnetic layer 3, and a magnetic recording layer 6 are stacked in this order on a substrate 1. Referring to FIG. 1, arrows represent the axes of easy magnetization. As shown in FIG. 1, this magnetic recording layer 6 includes first and second magnetic layers 4 and 5 having different axes of easy magnetization. A plurality of zones in the first and second magnetic layers 4 and 5 schematically represent the crystal sections of magnetic grains grown with inclined crystal orientations each other.

Another example of the structure in which epitaxial growth is interrupted is a combination of first and second magnetic layers having different crystal grain sizes of magnetic grains. The crystal grain size is preferably 5 to 20 nm. The difference between crystal grain sizes is preferably 2 to 5 nm.

FIG. 2 is a view showing a model which represents a magnetic recording medium having two magnetic layers different in crystal grain size.

As shown in FIG. 2, this magnetic recording medium has the same structure as FIG. 1 except that a magnetic recording layer 9 including first and second magnetic layers 7 and 8 different in crystal grain size is formed instead of the magnetic recording layer 6.

This structure in which epitaxial crystal growth is interrupted can be obtained by making the lattice constant of the second magnetic layer smaller by 4% or more or larger by 2% or more than the lattice constant of the first magnetic layer. In this case, the strain energy in the interface between the first and second magnetic layers increases, so the axes of each magnetization in the first and second magnetic layers are often inclined and do not match.

If, however, the lattice constant of the second magnetic layer falls within the range of −4% to +2% of the lattice constant of the first magnetic layer, epitaxial crystal growth is made and axes of each magnetization in the magnetic layers in the magnetic layers are in the same direction.

The structure in which epitaxial growth is interrupted can also be obtained by forming a first magnetic layer, exposing the surface of this first magnetic layer to oxygen to form an oxide layer on the first magnetic layer, and then forming a second magnetic layer on the oxide layer. In this structure, the easy axis of magnetization in the second magnetic layer is inclined to and does not match the easy axis of magnetization in the first magnetic layer.

The depth of the oxide layer is 4 nm or less, preferably, 0.5 to 2 nm. If this depth is larger than 4 nm, the magnetic coupling between the first and second magnetic layers weakens to make these layers vulnerable to thermal decay. If the depth is less than 0.5 nm, epitaxial growth often occurs.

The lattice constant of the second magnetic layer can be made smaller by 4% or less or larger by 2% or more than the lattice constant of the first magnetic layer by using cobalt-based magnetic layers as these first and second magnetic layers, adding 5 at % or less of platinum to the first magnetic layer, and adding 24 at % or more, preferably, 25 to 40 at % of platinum to the second magnetic layer.

It is also possible to use a stacked structure of three cobalt-based magnetic layers as a magnetic recording layer, add 24 at % or more, preferably, 25 to 75 at % of platinum to the first and third magnetic layers, and add 5 at % or less of platinum to the second magnetic layer.

FIG. 3 is a view showing an example of a magnetic recording medium having a magnetic recording layer in which three magnetic layers are stacked.

As shown in FIG. 3, this magnetic recording medium has the same structure as FIG. 1 except that a magnetic recording layer 17 including first, second, and third magnetic layers 14, 15, and 16 different in crystal grain size is formed instead of the magnetic recording layer 6.

Furthermore, in the present invention an interlayer can be formed between arbitrary layers of two or more magnetic layers.

For example, it is possible to use cobalt-based magnetic layers as first and second magnetic layers, add 20 at % or less, preferably, 5 to 20 at % of platinum to these first and second magnetic layers, and form between the first and second magnetic layers an interlayer containing a metal selected from the group consisting of ruthenium, titanium, and hafnium. In this magnetic recording layer, the second magnetic layer is grown such that its easy axis of magnetization is inclined with respect to the easy axis of magnetization in the first recording layer.

FIG. 4 is a view showing an example of a magnetic recording layer in which an interlayer is formed between first and second magnetic layers.

As shown in FIG. 4, this magnetic recording layer has the same structure as FIG. 1 except that a magnetic recording layer 13 made up of a first magnetic layer 10 containing, e.g., 66 at % of Co, 18 at % of Pt, and 16 at % of Cr, an interlayer 11 made of, e.g., hafnium, and a second magnetic layer 12 having the same composition as the first magnetic layer 10 is formed instead of the magnetic recording layer 6.

It is also possible to use HCP-phase cobalt-based magnetic layers as the first and second magnetic layers, add 20 at % or more, preferably, 20 to 30 at % of platinum to these first and second magnetic layers, and form an interlayer containing bcc-phase chromium between the first and second magnetic layers. In this magnetic recording layer, the second magnetic layer is grown such that its easy axis of magnetization is inclined to the easy axis of magnetization in the first recording layer.

An amorphous interlayer made of, e.g., carbon can be further formed between the first and second magnetic layers. This makes the crystal grain size of magnetic grains in the second magnetic layer of the magnetic recording layer different from that of magnetic grains in the first magnetic layer.

Examples of the material of the perpendicular magnetic recording layer used in the present invention are a Co—Cr—Pt-based alloy, Co—Cr—Pt—O-based alloy, Fe—Pt regular alloy, and Co/Pd—Co/Pt—Fe/Pt artificial lattice.

Furthermore, in the perpendicular magnetic recording medium of the present invention, it is possible to form, between the substrate and the magnetic recording layer, a bias application layer on the substrate and a soft magnetic layer on this bias application layer.

Examples of the bias application layer are a Co—Cr—Pt alloy, Co—Sm alloy, Co—Pt—O alloy, and Fe—Pt alloy.

Between the substrate and the bias application layer, it is possible to form a seed layer such as Ni—Al, TiN, copper, or MgO and an underlayer such as a Cr alloy, V alloy, or Ru alloy.

Before the perpendicular magnetic recording layer is formed, it is possible to form a seed layer such as Ti, Copper, or MgO and an underlayer such as Ru or nonmagnetic Co—Cr.

A magnetic recording/reading apparatus of the present invention comprises the perpendicular magnetic recording medium described above, driving means for supporting and rotating the magnetic recording medium, and a single-pole recording head which records information on the magnetic recording medium.

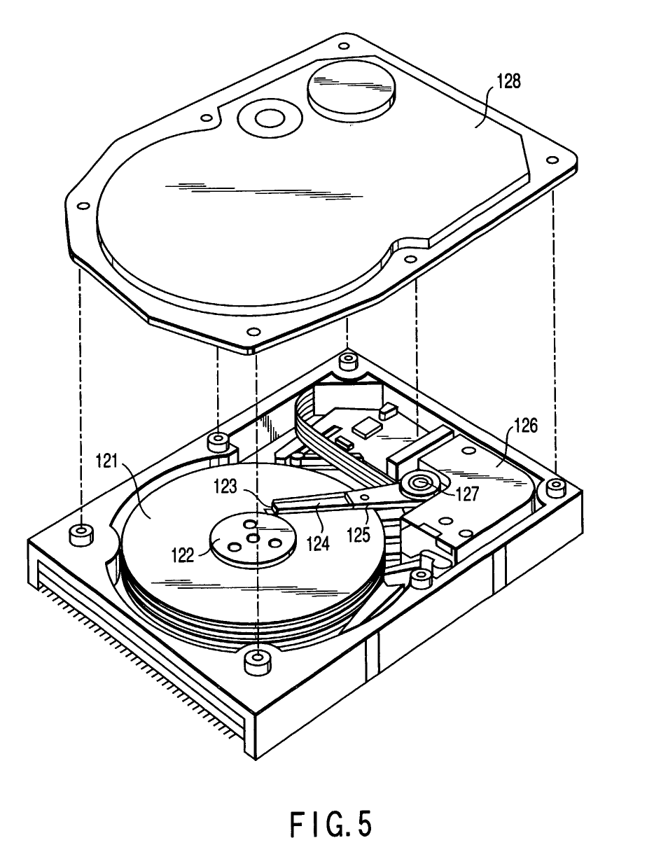

FIG. 5 is a partially exploded perspective view showing an example of the magnetic recording/reading apparatus according to the present invention.

A rigid magnetic disk 121 for recording information according to the present invention is fitted on a spindle 122 and rotated at a predetermined rotational speed by a spindle motor (not shown). A slider 123 is attached to the distal end portion of a suspension 124 which is a thin leaf spring. The slider 123 has mounted on it a single-pole recording head for accessing the magnetic disk 121 and recording information on this magnetic disk 121, and an MR head for recording/reading information. The suspension 124 is connected to one end portion of an arm 125 having a bobbin or the like which holds a driving coil (not shown).

A voice coil motor 126 which is a kind of a linear motor is attached to the other end of the arm 125. This voice coil motor 126 comprises a driving coil (not shown) wound on the bobbin of the arm 125, and a magnetic circuit including a permanent magnet and a counter yoke which oppose each other to sandwich the driving coil.

The arm 125 is held by ball bearings (not shown) formed in two, upper and lower portions of a fixed shaft 127 and pivoted by the voice coil motor 126. That is, the position of the slider 123 on the magnetic disk 121 is controlled by the voice coil motor 126. Reference numeral 128 in FIG. 5 denotes a lid.

The present invention will be explained in more detail below by way of examples.

### EXAMPLE 1

First, a 2.5-inch crystallized glass substrate was prepared. On this 2.5-inch crystallized glass substrate, a 5-nm-thick Ni—Al seed layer, 10-nm-thick Cr alloy underlayer, and 30-nm-thick Co₆₈Cr₁₂Pt₂₀ alloy longitudinal hard magnetic film were formed in this order by sputtering. After that, a 150-nm-thick Co—Zr—Nb soft magnetic film was formed by sputtering on the Co—Cr—Pt alloy longitudinal hard magnetic film. On this Co—Zr—Nb soft magnetic film, a Ti-alloy seed layer and an Ru alloy underlayer were formed for a perpendicular recording layer. A 15-nm-thick Co₇₃Pt₅Cr₂₂ alloy film was then formed as a first perpendicular magnetic layer by sputtering. On this first perpendicular magnetic layer, a 15-nm-thick second perpendicular magnetic layer was formed using a Co₆₄Pt₂₄Cr₁₂ target in an oxygen-containing Ar gas atmosphere. The Pt component of the target was so chosen that the lattice constant would be larger by 2% or more than that of the first perpendicular magnetic layer. Furthermore, 6-nm thick CVD carbon was formed on this second perpendicular magnetic layer, and a perfluoropolyether lubricant layer was formed by dipping, thereby manufacturing a perpendicular magnetic recording medium. Finally, the obtained longitudinal hard magnetic film was magnetized in the radial direction by applying enough large magnetic field.

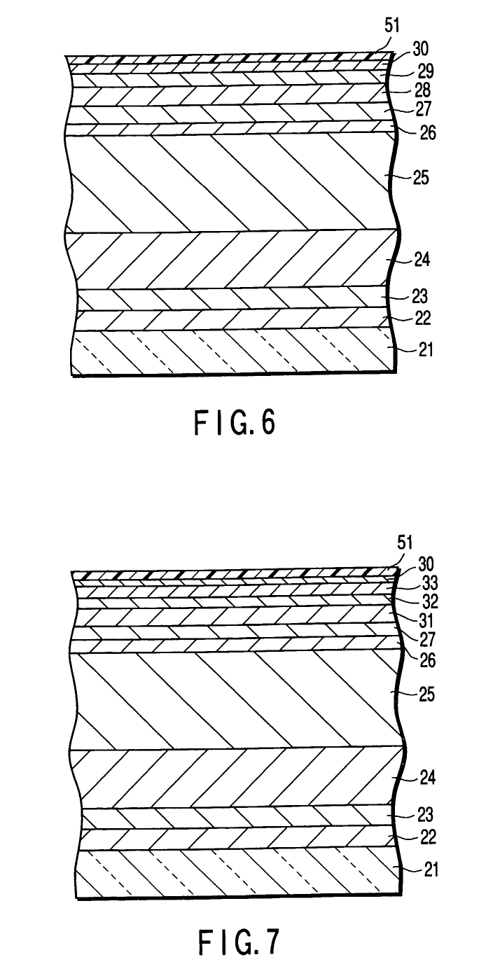

FIG. 6 is a schematic sectional view showing the structure of the obtained magnetic recording medium.

As shown in FIG. 6, this magnetic recording medium has a structure in which an Ni—Al seed layer 22, a Cr alloy underlayer 23, a Co—Cr—Pt alloy bias application layer 24, a Co—Zr—Nb soft magnetic layer 25, a Ti alloy seed layer 26, an Ru alloy underlayer 27, a first perpendicular magnetic layer 28 made of a Co₇₃PtsCr₂₂ alloy, a second perpendicular magnetic layer 29 made of a Co₆₄Pt₂₄Cr₁₂ alloy, and a protective layer 30 are stacked in this order by sputtering on a 2.5-inch crystallized glass substrate 21, and a perfluoropolyether lubricant layer 51 is formed by dip coating on the protective layer 30 made of CVD.

The sectional structure of the magnetic recording layer including the first and second perpendicular magnetic layers was observed by a transmission electron microscope (TEM). Consequently, the boundary between the first and second perpendicular magnetic layers was clear, and epitaxial growth in the film thickness direction was interrupted in this boundary. In this structure, a difference was found in the C-axis growth direction, i.e., the axis of easy crystal magnetization, between HCP structure grains in the second perpendicular magnetic layer and HCP structure grains in the first perpendicular magnetic layer.

Information was recorded on and reproduced from the obtained magnetic recording medium by using a single-pole recording head having a recording track width of 0.4 μm and a GMR reproduction head having a recording/reading track width of 0.3 μm. The SNR of the medium noise (Nmrms) at 400-kFCI to the isolated read-signal (So) at 46 kFCI was 23.0 (dB). The obtained results are shown in Table 1.

### COMPARATIVE EXAMPLE 1

For comparison, a perpendicular magnetic recording medium was manufactured following the same procedures as in Example 1, except that only a 30-nm thick first perpendicular magnetic layer was formed without forming any second perpendicular magnetic layer.

When the sectional structure of this film was observed, epitaxial growth was not interrupted in the film thickness direction of the recording layer. The SNR was as low as 20.5 (dB). The obtained results are shown in Table 1.

### COMPARATIVE EXAMPLE 2

For comparison, a perpendicular magnetic recording medium was manufactured following the same procedures as in Example 1, except that only a 30-nm thick second perpendicular magnetic layer was formed without forming any first perpendicular magnetic layer.

When the sectional structure of this film was observed, epitaxial growth was not interrupted in the film thickness direction of the recording layer. The SNR was as low as 20.3 (dB). The obtained results are shown in Table 1.

### COMPARATIVE EXAMPLE 3

For comparison, a perpendicular magnetic recording medium was manufactured following the same procedures as in Example 1, except that a Co₇₃Pt₁₅Cr₁₂ alloy layer was formed as a first perpendicular magnetic layer by sputtering such that its lattice constant was substantially equal to that of a second perpendicular magnetic layer.

When the sectional structure of this film was observed, epitaxial growth was not interrupted in the film thickness direction of the recording layer. The SNR was as low as 20.2 (dB). The obtained results are shown in Table 1.

### COMPARATIVE EXAMPLE 4

For comparison, a perpendicular magnetic recording medium was manufactured following the same procedures as in Example 1, except that a Co₆₈Pt₂₀Cr₁₂ alloy layer was formed as a first perpendicular magnetic layer by sputtering such that its lattice constant was substantially equal to that of a second perpendicular magnetic layer.

When the sectional structure of this film was observed, epitaxial growth was not interrupted in the film thickness direction of the recording layer. The SNR was as low as 20.4 (dB). The obtained results are shown in Table 1.

### EXAMPLE 2

A perpendicular magnetic recording medium was manufactured following the same procedures as in Example 1, except that a second perpendicular magnetic layer was formed by removing Cr from the second perpendicular magnetic layer material so that the lattice constant of this second perpendicular magnetic layer was larger by +2% or more than that of a first perpendicular magnetic layer.

When the sectional structure of this film was observed, epitaxial growth was interrupted in the film thickness direction of the recording layer. The SNR was 23.3 (dB). The obtained results are shown in Table 1.

### EXAMPLE 3

A perpendicular magnetic recording medium was manufactured following the same procedures as in Example 1, except that a second perpendicular magnetic layer was formed by adding 18 at % of Cr so that the lattice constant of this second perpendicular magnetic layer was larger by +2% or more than that of a first perpendicular magnetic layer.

When the sectional structure of this film was observed, epitaxial growth was interrupted in the film thickness direction of the recording layer. The SNR was 23.5 (dB). The obtained results are shown in Table 1.

### EXAMPLE 4

A 2.5-inch crystallized glass substrate was prepared. On this substrate, a 5-nm thick Ni—Al seed layer, 5-nm-thick Cr alloy underlayer, and 40-nm thick Co₆₆Cr₁₈Pt₁₆ alloy longitudinal hard magnetic film were formed in this order by sputtering. The obtained longitudinal hard magnetic film was magnetized in the radial direction. After that, a 150-nm-thick Co—Zr—Nb soft magnetic film was formed on the longitudinal hard magnetic film by sputtering. On this Co—Zr—Nb soft magnetic film, a Ti alloy seed layer and an Ru alloy underlayer were formed for a perpendicular recording layer. A 15-nm-thick Co—Pt—Cr—O film was then formed as a first perpendicular recording film by sputtering in an oxygen-containing Ar gas atmosphere by using a Co₆₄Pt₂₀Cr₁₆ alloy target. On this first perpendicular recording film, an Ru₉₀Ti₁₀ alloy interlayer having a thickness of 3 nm or less was formed. The lattice constant of this interlayer was larger by 2% or more than that of the first magnetic film. On this interlayer, a 15-nm-thick Co₆₂Pt₂₀Cr₁₈ alloy film was directly formed as a second perpendicular magnetic layer. The lattice constant of this second perpendicular magnetic film was smaller by 4.05% than that of the interlayer. Furthermore, 6-nm-thick CVD carbon was formed on this second perpendicular magnetic layer by sputtering. Finally, a perfluoropolyether lubricant layer was formed by dip coating to manufacture a perpendicular magnetic recording medium.

FIG. 7 is a schematic sectional view showing the structure of the obtained magnetic recording medium.

As shown in FIG. 7, this magnetic recording medium has the same structure as Example 1, except that on an Ru alloy underlayer 27, a Co₆₄Pt₂₀Cr₁₆ alloy first perpendicular magnetic layer 31, an Ru₉₀Ti₁₀ alloy interlayer 32, and a Co₆₈Pt₂₀Cr₁₈ alloy second perpendicular magnetic layer 33 are formed instead of the first and second perpendicular magnetic layers 28 and 29.

The sectional structure of this film was observed by the TEM. Consequently, in the position of film thickness which was presumably the boundary between the first and second magnetic films, the crystal boundary was clear and epitaxial crystal growth was interrupted between the upper and lower magnetic films.

The SNR of the medium noise (Nmrms) at 400-kFCI to the isolated read-signal (So) at 46 kFCI was 23.3 (dB). The obtained results are shown in Table 2.

### COMPARATIVE EXAMPLE 5

As a comparative example, a perpendicular magnetic recording medium was manufactured following the same procedures as in Example 4, except that a Cu interlayer was used instead of the Ru₉₀Ti₁₀ alloy interlayer so that the lattice constant of this interlayer fell within 1% of that of a first perpendicular magnetic layer and the lattice constant of a second perpendicular magnetic layer was within 4% of that of the interlayer.

When the sectional structure of this film was observed by the TEM, the first and second magnetic films were epitaxially grown.

The SNR of the medium noise (Nmrms) at 400-kFCI to the isolated read-signal (So) at 46 kFCI was as low as 20.6 (dB). The obtained results are shown in Table 2.

### EXAMPLE 5

A perpendicular magnetic recording medium was manufactured following the same procedures as in Example 4, except that Hf by which the lattice constant of an interlayer was different by 20% or more from that of a second recording layer was used instead of the R₉₀Ti₁₀ alloy interlayer.

When the sectional structure of this film was observed by the TEM, the axes of easy magnetization in the first and second magnetic films did not match.

The SNR of the medium noise (Nmrms) at 400-kFCI to the isolated read-signal (So) at 46 kFCI was 23.9 (dB). In addition, a lowering of the coercive force of the magnetic recording layer was significant. The obtained results are shown in Table 2.

### EXAMPLE 6

A perpendicular magnetic recording medium was manufactured following the same procedures as in Example 4, except that 2-nm-thick Cr having a BCC structure Hf by which the lattice constant of an interlayer was different by 2.18% from that of a second recording layer was used instead of the Ru₉₀Ti₁₀ alloy interlayer.

When the sectional structure of this film was observed by the TEM, the normal directions of the fine surfaces of the first and second perpendicular magnetic layers, i.e., the axes of easy magnetization in these first and second perpendicular magnetic layers were different.

The SNR of the medium noise (Nmrms) at 400-kFCI to the isolated reproduced-signal (So) at 46 kFCI was 23.2 (dB). The obtained results are shown in Table 2.

### EXAMPLE 7

A perpendicular magnetic recording medium was manufactured following the same procedures as in Example 4, except that amorphous C formed by sputtering was used instead of the Ru₉₀Ti₁₀ alloy interlayer.

When the sectional structure of this film was observed by the TEM, the crystal grain sizes of the first and second perpendicular magnetic layers were different.

The SNR of the medium noise (Nmrms) to the reproduced solitary at 400-kFCI wave (SO) was 23.6 (dB). The obtained results are shown in Table 2.

When the amorphous material was used as an interlayer, a difference was found between the crystal grain sizes of the first and second magnetic layers. When this crystal grain size difference is found, a zigzag shape of magnetization transition in the first magnetic layer differs from that in the second magnetic layer. Accordingly, noise components are not equalized but averaged, and this improves the SNR.

### EXAMPLE 8

A perpendicular magnetic recording medium was manufactured following the same procedures as in Example 4, except that after a first perpendicular magnetic layer was formed, the resultant structure was exposed to an oxygen gas atmosphere to form an oxide layer on the first perpendicular magnetic layer, and then a second recording layer having the same composition as the first perpendicular magnetic layer was formed.

When the sectional structure of this film was observed by the TEM, the crystal axes of easy magnetization in the first and second perpendicular magnetic layers were different.

The SNR of the medium noise (Nmrms) at 400-kFCI to the isolated reproduced-signal (So) at 46 kFCI was 23.1 (dB). The obtained results are shown in Table 2.

### EXAMPLE 9

A 5-nm-thick Ni—Al seed layer, 5-nm-thick Cr alloy underlayer, and 50-nm-thick Co₆₄Cr₂₀Pt₁₆ alloy longitudinal hard magnetic film were formed in this order on a 2.5-inch crystallized glass substrate by sputtering. The obtained longitudinal hard magnetic film was magnetized in the radial direction. A 150-nm-thick Co—Zr—Nb soft magnetic film was formed on the longitudinal hard magnetic film. On this soft magnetic film, a Ti alloy seed layer as a perpendicular recording layer and an Ru alloy underlayer were formed. A 12-nm-thick Co—Pt—Cr alloy film was then formed as a first perpendicular magnetic layer by using a Co₆₈Pt₂₀Cr₁₂ alloy target. On this first perpendicular magnetic layer, a 5-nm-thick Co₇₄Pt₅Cr₂₀B₁ alloy film was formed as a second magnetic layer. Furthermore, a 12-nm-thick Co₅₅Cr₂₁Pt₂₄ alloy film was formed as a third perpendicular magnetic layer on the second magnetic layer. Finally, 6-nm-thick CVD carbon was formed on the third perpendicular magnetic layer, and a perfluoropolyether lubricant layer was formed by dipping to manufacture a perpendicular magnetic recording medium.

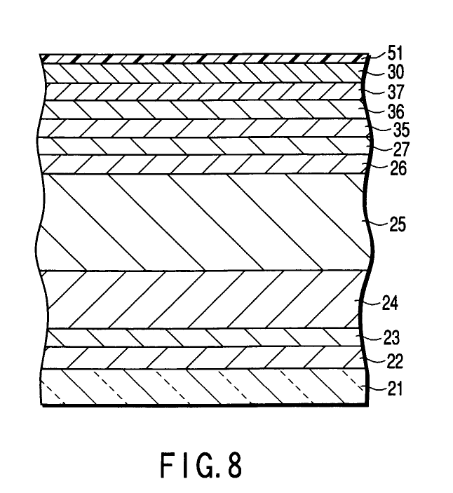

FIG. 8 is a schematic sectional view showing the structure of the obtained magnetic recording medium.

As shown in FIG. 8, this magnetic recording medium has the same structure as Example 4, except that on an Ru alloy underlayer 27, first, second, and third perpendicular magnetic layers 35, 36, and 37 are formed instead of the first and second perpendicular magnetic layers 28 and 29.

The lattice constant of the second perpendicular magnetic layer was smaller by 1.63% than that of the first perpendicular magnetic layer. The lattice constant of the third perpendicular magnetic layer was larger by 2.10% than that of the second perpendicular magnetic layer.

The sectional structure of the first to third perpendicular magnetic layers was observed, and no interruption of growth was found between the first and second recording layers. However, epitaxial growth was interrupted between the second and third magnetic films. The results are shown in Table 3.

### COMPARATIVE EXAMPLE 6

For comparison, a perpendicular magnetic recording medium was manufactured following the same procedures as in Example 9, except that a Co₆₄Pt₂₀Cr₁₆ alloy layer was used as a first perpendicular magnetic layer and a Co₆₂Pt₂₂Cr₁₆ alloy layer was used as a second perpendicular magnetic layer such that the lattice constant of this second perpendicular magnetic layer fell within 2% of those of the first perpendicular magnetic layer and a third perpendicular magnetic layer.

When the sectional structure of the first to third perpendicular magnetic layers was observed, epitaxial growth was found between the first to third perpendicular magnetic layers.

The SNR of the medium noise (Nmrms) at 400-kFCI to the isolated read-signal (So) at 46 kFCI was as low as 20.4 (dB).

The results are shown in Table 3.

TABLE 1

| | Target composition | | Target composition | | | Interrupt | |
|---|---|---|---|---|---|---|---|
| | and film thickness | | and film thickness | | Lattice constant | ion of | |
| | of first magnetic | | of second magnetic | | difference | epitaxial | SNRm |
| | film | | film | | (=second/first) | growth | (dB) |
| Example 1 | Co₇₃Pt₅Cr₂₂ | 15 nm | Co₆₄Pt₂₄Cr₁₂ | 15 nm | 2.1% | Found | 23.0 |
| Comparative | Co₇₃Pt₅Cr₂₂ | 30 nm | Not found | Not | 0 | Not found | 20.5 |
| Example 1 | | | | found | | | |
| Comparative | Not found | Not | Co₆₄Pt₂₄Cr₁₂ | 30 nm | 0 | Not found | 20.3 |
| Example 2 | | found | | | | | |
| Comparative | Co₇₃Pt₁₅Cr₁₂ | 15 nm | Co₆₄Pt₂₄Cr₁₂ | 15 nm | 0.98% | Not found | 20.4 |
| Example 3 | | | | | | | |
| Comparative | Co₆₈Pt₂₀Cr₁₂ | 15 nm | Co₆₄Pt₂₄Cr₁₂ | 15 nm | 0.44% | Not found | 20.4 |
| Example 4 | | | | | | | |
| Example 2 | Co₇₃Pt₅Cr₂₂ | 15 nm | Co₇₆Pt₂₄ | 15 nm | 2.1% | Found | 23.3 |
| Example 3 | Co₇₃Pt₅Cr₂₂ | 15 nm | Co₅₈Pt₂₄Cr₁₈ | 15 nm | 2.0% | Found | 23.5 |

TABLE 2

| | | | | | | | Lattice constant | | Inter- | |
|---|---|---|---|---|---|---|---|---|---|---|
| | Target composition | | | | Target composition | | difference | | ruption | |
| | and film thickness | | | | and film thickness | | (= | | of | |
| | of first magnetic | | | | of second magnetic | | interlayer/ | (= second/ | epitaxial | |
| | film | | Interlayer | | film | | first) | interlayer) | growth | SNRm |
| Example 4 | Co₆₄Pt₂₀Cr₁₆ | 15 nm | Ru₉₀Ti₁₀ | 3 nm | Co₆₂Pt₂₀Cr₁₈ | 15 nm | 4.79% | −4.57% | Found | 23.3 |
| Comparative | Co₆₄Pt₂₀Cr₁₆ | 15 nm | Cu | 3 nm | Co₆₂Pt₂₀Cr₁₈ | 15 nm | 0.14% | −0.14% | Not found | 20.6 |
| Example 5 | | | | | | | | | | |
| Example 5 | Co₆₄Pt₂₀Cr₁₆ | 15 nm | Hf | 3 nm | Co₆₂Pt₂₀Cr₁₈ | 15 nm | 22.5% | −18.4% | Found | 23.9 |
| Example 6 | Co₆₄Pt₂₀Cr₁₆ | 15 nm | Cr | 2 nm | Co₆₂Pt₂₀Cr₁₈ | 15 nm | −2.1% | 2.18% | Found | 23.2 |
| Example 7 | Co₆₄Pt₂₀Cr₁₆ | 15 nm | Amorphous | 3 nm | Co₆₂Pt₂₀Cr₁₈ | 15 nm | — | — | Found | 23.6 |
| | | | C | | | | | | | |

| | | | | | | | | | |
|---|---|---|---|---|---|---|---|---|---|
| Example 8 | Co₆₄Pt₂₀Cr₁₆ | 15 nm | Exposure to | Co₆₄Pt₂₀Cr₁₆ | 15 nm | — | — | Found | 23.1 |
| | | | oxygen | | | | | | |

TABLE 3

| | Target composition | | Target composition | | Target composition | | Lattice constant | | Inter- | |
|---|---|---|---|---|---|---|---|---|---|---|
| | and film thickness | | and film thickness | | and film thickness | | difference | | ruption of | |
| | of first magnetic | | of second magnetic | | of third magnetic | | (= second/ | (= third/ | epitaxial | |
| | film | | film | | film | | first) | second) | growth | SNRm |
| Example 9 | Co₆₈Pt₂₀Cr₁₂ | 12 nm | Co₇₄Pt₅Cr₂₀B₁ | 5 nm | Co₅₅Pt₂₄Cr₂₁ | 12 nm | −1.63% | 2.10% | Found | 23.6 |
| Comparative | Co₆₄Pt₂₀Cr₁₆ | 12 nm | Co₆₂Pt₂₂Cr₁₆ | 5 nm | Co₅₅Pt₂₄Cr₂₁ | 12 nm | −0.87% | 1.32% | Not found | 20.4 |
| Example 6 | | | | | | | | | | |

In the present invention as described above, magnetic recording can be performed with a high thermal decay resistance and a high medium SNR. Also, the present invention can increase the thermal decay resistance and medium SNR of a magnetic recording medium even when the film thickness of a magnetic recording layer is as small as 50 nm or smaller.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

What is claimed is:

1. A perpendicular magnetic recording medium comprising a substrate, and a perpendicular magnetic recording layer which is formed on said substrate and in which epitaxial growth is interrupted.

2. A medium according to claim 1, wherein said perpendicular magnetic recording layer comprises two or more magnetic layers.

3. A medium according to claim 2, wherein said perpendicular magnetic recording layer comprises a first magnetic layer, an interlayer formed on said first magnetic layer, and a second magnetic layer formed on said interlayer.

4. A medium according to claim 2, wherein said perpendicular magnetic recording layer comprises a first magnetic layer, and a second magnetic layer which is formed on said first magnetic layer and in which the easy axis of magnetization of magnetic grains does not match the easy axis of magnetization of magnetic grains in said first magnetic layer.

5. A medium according to claim 4, wherein said second magnetic layer is formed after said first magnetic layer is exposed to oxygen.

6. A medium according to claim 4, wherein the lattice constant of said second magnetic layer is smaller by not less than 4% or larger by not less than 2% than the lattice constant of said first magnetic layer.

7. A medium according to claim 6, wherein said first and second magnetic layers are cobalt-based magnetic layers, said first magnetic layer contains not more than 5 at % of platinum, and said second magnetic layer contains not less than 24 at % of platinum.

8. A medium according to claim 6, further comprising a third magnetic layer formed on said second magnetic layer, wherein said first, second, and third magnetic layers are cobalt-based magnetic layers, said first and third magnetic layers contain not less than 24 at % of platinum, and said second magnetic layer contains not more than 5 at % of platinum.

9. A medium according to claim 4, wherein said first and second magnetic layers are cobalt-based magnetic layers and contain not more than 20 at % of platinum, and said perpendicular magnetic recording medium further comprises an interlayer formed between said first and second magnetic layers and containing a metal selected from the group consisting of ruthenium, titanium, and hafnium.

10. A medium according to claim 4, wherein said first and second magnetic layers are cobalt-based magnetic layers and contain not less than 20 at % of platinum, and said perpendicular magnetic recording medium further comprises an interlayer formed between said first and second magnetic layers and containing chromium.

11. A medium according to claim 2, wherein said perpendicular magnetic recording layer includes a first magnetic layer, and a second magnetic layer which is formed on said first magnetic layer and in which the crystal grain size of magnetic grains is different from the crystal grain size of magnetic grains in said first magnetic layer.

12. A medium according to claim 1, further comprising an amorphous interlayer between first and second magnetic layers.

13. A medium according to claim 1, further comprising, between said substrate and said perpendicular magnetic recording layer, a bias application layer formed on said substrate and a soft magnetic layer formed on said bias application layer.

14. A magnetic recording/reading apparatus comprising:
a perpendicular magnetic recording medium having a substrate, and a perpendicular magnetic recording layer which is formed on said substrate and in which epitaxial growth is interrupted;
driving means for supporting and rotating said magnetic recording medium; and
a single-pole recording head which records information on said magnetic recording medium.

15. An apparatus according to claim 14, wherein said perpendicular magnetic recording layer comprises not less than two magnetic layers.

16. An apparatus according to claim 15, wherein said perpendicular magnetic recording layer comprises a first magnetic layer, an interlayer formed on said first magnetic layer, and a second magnetic layer formed on said interlayer.

17. An apparatus according to claim 15, wherein said perpendicular magnetic recording layer comprises a first magnetic layer, and a second magnetic layer which is formed on said first magnetic layer and in which the easy axis of magnetization of magnetic grains does not match the easy axis of magnetization of magnetic grains in said first magnetic layer.

18. An apparatus according to claim 17, wherein said second magnetic layer is formed after said first magnetic layer is exposed to oxygen.

19. An apparatus according to claim 17, wherein the lattice constant of said second magnetic layer is smaller by not less than 4% or larger by not less than 2% than the lattice constant of said first magnetic layer.

20. An apparatus according to claim 19, wherein said first and second magnetic layers are cobalt-based magnetic layers, said first magnetic layer contains not more than 5 at % of platinum, and said second magnetic layer contains not less than 24 at % of platinum.

21. An apparatus according to claim 19, further comprising a third magnetic layer formed on said second magnetic layer, wherein said first, second, and third magnetic layers are cobalt-based magnetic layers, said first and third magnetic layers contain not less than 24 at % of platinum, and said second magnetic layer contains not more than 5 at % of platinum.

22. An apparatus according to claim 17, wherein said first and second magnetic layers are cobalt-based magnetic layers and contain not more than 20 at % of platinum, and said perpendicular magnetic recording medium further comprises an interlayer formed between said first and second magnetic layers and containing a metal selected from the group consisting of ruthenium, titanium, and hafnium.

23. An apparatus according to claim 17, wherein said first and second magnetic layers are cobalt-based magnetic layers and contain not less than 20 at % of platinum, and said perpendicular magnetic recording medium further comprises an interlayer formed between said first and second magnetic layers and containing chromium.

24. An apparatus according to claim 15, wherein said perpendicular magnetic recording layer includes a first magnetic layer, and a second magnetic layer which is formed on said first magnetic layer and in which the crystal grain size of magnetic grains is different from the crystal grain size of magnetic grains in said first magnetic layer.

25. An apparatus according to claim 14, further comprising an amorphous interlayer between first and second magnetic layers.

26. An apparatus according to claim 14, further comprising, between said substrate and said perpendicular magnetic recording layer, a bias application layer formed on said substrate and a soft magnetic layer formed on said bias application layer.
